(19) United States
(12) Patent Application Publication
(10) Pub. No.: US 2004/0208721 A1
(43) Pub. Date: Oct. 21, 2004

(54) Fastener adapted for use with a structural member

(76) Inventor: Rainer Kuenzel, Hunt, TX (US)

Correspondence Address: AKIN, GUMP, STRAUSS, HAUER & FELD, 1111 LOUISIANA STREET, 44TH FLOOR, HOUSTON, TX, 77002, US

(21) Appl. No.: 10/418,448

(22) Filed: Apr. 17, 2003

(51) Int. Cl. F16B 21/00

(52) U.S. Cl. 411/340

(57) ABSTRACT

A holding portion of a fastener including a housing and more than one elongated members disposed with the housing is disclosed. The elongated members move between an insertion position and an extended position. Upon insertion of the holding portion in an aperture, the elongated members are in the insertion position. Upon clearance of the holding portion from the aperture, the elongated members are in the extended position to resist removal of the holding member through the aperture. Additionally, a method of fastening an element to a structural member is provided.

### CROSS-REFERENCE TO RELATED APPLICATIONS

Not Applicable.

### STATEMENTS REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

1. Field of the Invention

The present invention relates generally to fasteners and, in particular, to a blind fastener.

2. Description of the Related Art

The general concept of fastening is the fixing or bringing together of two distinct items or devices with a fastener. In the positioning of an element with a structural member, such as a wall, ceiling, floor, substrate or other supporting structure, one particular type of fastener, generally known as a blind fastener, allows positioning of the element without access to one side of the structural member. The blind fastener accomplishes this fastening by allowing a holding portion and a rod (e.g., a stud, bolt, or the like) to be inserted through an aperture in the structural member, and then resists removal of the holding portion through the aperture. There have been fasteners known in the past that are moved through an aperture in a structural member during insertion and, thereafter, resist removal of the fastener.

One type of blind fastener is what is known as a toggle bolt. The general concept of a toggle bolt is a bolt with a nut having pivotally attached elongated members or wings. The wings of the toggle bolt retract during passage through the aperture and, thereafter, spring open or expand to resist removal of the bolt back through the aperture. Examples of toggle bolts include U.S. Pat. Nos. 2,024,871; 4,793,755; 4,997,327; 5,209,621; 5,224, 807; and 6,203,260. Three characteristics of the toggle bolt are (1) each wing's bearing line area or contact with the blind side of the structural member, (2) the plurality of components for “spring” pivoting action of each wing, and (3) the sizing of the aperture, having an area larger than the cross-sectional area of the bolt, to allow insertion of the wings in their retracted position.

Another type of blind fastener is what is known as a “molly bolt”—also known as a “hollow wall anchor”. The general concept of a molly bolt is a bolt connected to a body having a pair of elongated members or wings and two housings. The housings are initially spaced apart from one another with the ends of each wing being in contact with one of the housings. During insertion of the molly bolt, the wings are retracted towards the bolt. Then, after insertion, as the housings are moved closer to each other the wings extend outwardly. The general operation of the molly bolt is discussed in U.S. Pat. Nos. 3,888,156; 4,152,968; 4,307,598; and 5,509,765. While molly bolts need not have a spring to extend the wings outwardly, two characteristics of the molly bolt design are (1) precision insertion of the body to ensure proper deformation of the wings for the desired structural support, and (2) precision threading and deforming of the wings to, once again, allow the desired structural support.

Other types of blind fasteners include those proposed in U.S. Pat. No. 4,086,840 issued to Kurlander and U.S. Pat. No. 5,944,466, issued to Rudnicki, et al. along with rivets. The '840 Kurlander patent proposes a fastener having a nut integral with an elastomeric conical member adapted to deform or collapse radially and longitudinally when compressed. Upon insertion of the fastener through an aperture in a structural member, the elastomeric conical collapses radially inwardly. After insertion, the bolt is threaded with the integral nut and the elastomeric conical member collapses in a longitudinal direction against the structural member.

The '466 Rudnicki patent, concerned with loading by an anchoring assembly or holding portion of fastener on the structural member, proposes that the radial distance between the points of support provided by an anchoring assembly and the bolt are too short for large loads. (Col. 1, lns. 45-58.) The '466 Rudnicki patent proposes a fastener assembly to extend the radial distance between the points of support provided by the anchoring assembly and the bolt as a solution to this loading concern. (Col. 4, lns. 16-26.) The proposed fastener assembly includes a face plate, an anchoring assembly, and a positioner. The face plate is positioned on a surface of the structural member. The anchoring assembly includes a base portion and a support structure. Upon insertion of the anchoring assembly through an aperture in the structural member, the support structure extends outwardly from the base portion to three or more radially equidistant regions isolated from the peripheral edge of the aperture in the structural member.

It would be desirable to provide a simple, yet effective, fastener which provides the necessary structural support to fasten an element to a structural member. Additionally, it would be desirable to provide a fastener which optimizes the bearing area to distribute the loading by the holding portion on the structural member while decreasing the number of component parts of the elongated rigid members or wings.

### SUMMARY OF THE INVENTION

Fasteners generally includes rods, which are used to fasten elements to a structural member using an aperture in the structural member. According to the invention, a holding portion of the fastener comprises a housing and a plurality of elongated members disposed with the housing. The plurality of elongated members are moveable between an insertion position and an extended position. Upon insertion of the holding portion in the aperture, the plurality of elongated members are in the insertion position. Then, upon clearance of the holding portion from the aperture, the plurality of elongated members are in the extended position to resist removal of the holding member through the aperture. In one embodiment of the invention, a length of engagement of the holding portion is greater than one-third of a length of a perimeter of a cross-sectional area of the rod. In another embodiment of the invention, the plurality of elongated members are moved to the extended position using a tapered sleeve. In a further embodiment of the invention, the plurality of elongated members are moved to the extended position using a compressive band. In yet another embodiment of the invention, an end surface area of the plurality of elongated members is substantially the difference between a cross-sectional area of the aperture and a cross-sectional area of the rod. In yet a further embodiment, at least one of the elongated members has a curvature.

Additionally, according to invention, an improved method of fastening an element to a structural member is provided. The rod is coupled to a housing of the holding portion, which includes a plurality of elongated members. The holding portion is then inserted into an aperture of the structural member. After insertion through the aperture, the holding portion is moved to an extended position to form a bearing surface area. Then, the plurality of elongated members are moved into bearing contact with the structural member. In one embodiment of the invention, a length of engagement of the holding portion is greater than one-third of a length of a perimeter of a cross-sectional area of the rod. In another embodiment of the invention, during the step of contacting the structural member, the elongated members maintain positional relationship with the rod. In a further embodiment of the invention, during the step of inserting the holding portion through the aperture, an end surface area of the plurality of elongated members is substantially the difference between a cross-sectional area of the aperture and a cross-sectional area of the rod.

### BRIEF DESCRIPTION OF THE SEVERAL VIEWS OF THE DRAWINGS

A better understanding of the present invention can be obtained when the following detailed description of the disclosed embodiments is considered in conjunction with the following drawings, in which:

FIG. 1 is one embodiment of an internally threaded holding portion of the fastener of the present invention, shown in a perspective view;

FIG. 2 is a cross-sectional elevational view of the holding portion of the fastener taken across lines 2-2 of FIG. 1;

FIG. 3 is an end view of the embodiment of the holding portion of the fastener shown in FIG. 1;

FIG. 4 is an illustration of the embodiment of the holding portion of the fastener, shown in FIG. 1, in the insertion position while being inserted through an aperture in a structural member using a threaded rod;

FIG. 5 is an illustration of the embodiment of the holding portion of the fastener, similar to FIG. 4, in the extended position after insertion through the aperture;

FIG. 6 is an illustration of the embodiment of the extended holding portion of the fastener, similar to FIG. 5, in the engaged or bearing position to position the element, shown in the phantom view, using a washer and nut threadingly received on the threaded rod;

FIG. 7 is another embodiment of an internally threaded holding portion of a fastener, shown in a cross-sectional elevation view;

FIG. 8 is an end view of the embodiment of the holding portion of the fastener shown in FIG. 7;

FIG. 9 is an illustration of the embodiment of the holding portion of the fastener of FIG. 7, after insertion through an aperture in a structural member, using a threaded bolt along with a tapered sleeve and a spacer of predetermined length to move the holding portion to the extended position upon tightening the bolt head of the bolt with the holding portion;

FIG. 10 is an illustration of the embodiment of the holding portion of the fastener, similar to FIG. 9, in the extended position and engaged or bearing position after the holding portion is threaded upon the bolt;

FIG. 11 is yet another embodiment of the holding portion of a fastener in the extended position, shown in a cross-sectional view with a part of the holding portion shown in phantom view, and the bolt shown in elevational view;

FIG. 12 is an illustration of the embodiment shown in FIG. 11, with the holding portion shown in the insertion position while being inserted through an aperture in a structural member;

FIG. 13 is an illustration of the embodiment shown in FIG. 11, with the holding portion shown in the extended and engaged or bearing position and element shown in phantom view; and

FIG. 14 is an end view of the embodiment of the fastener taken along lines 14-14 of FIG. 13 with the holding portion shown in solid lines when in the extended position and shown in phantom view when in the insertion position.

### DETAILED DESCRIPTION OF THE INVENTION

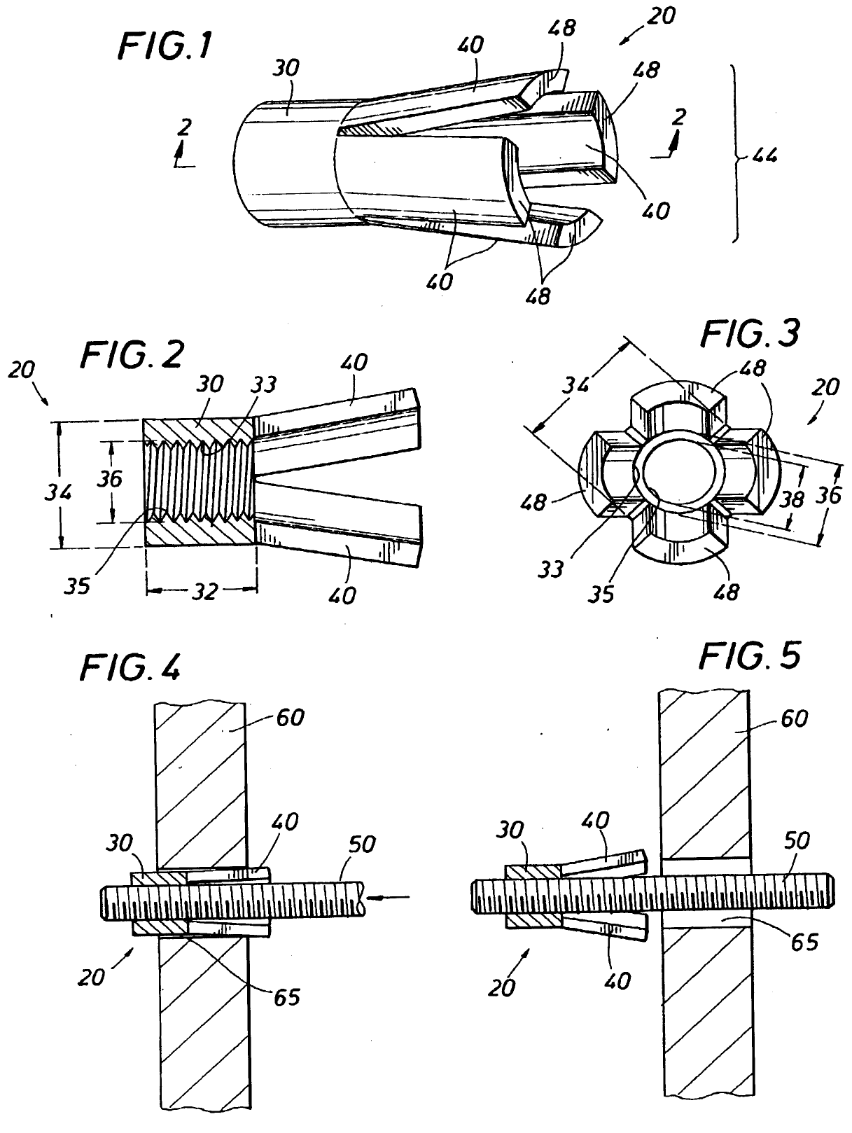

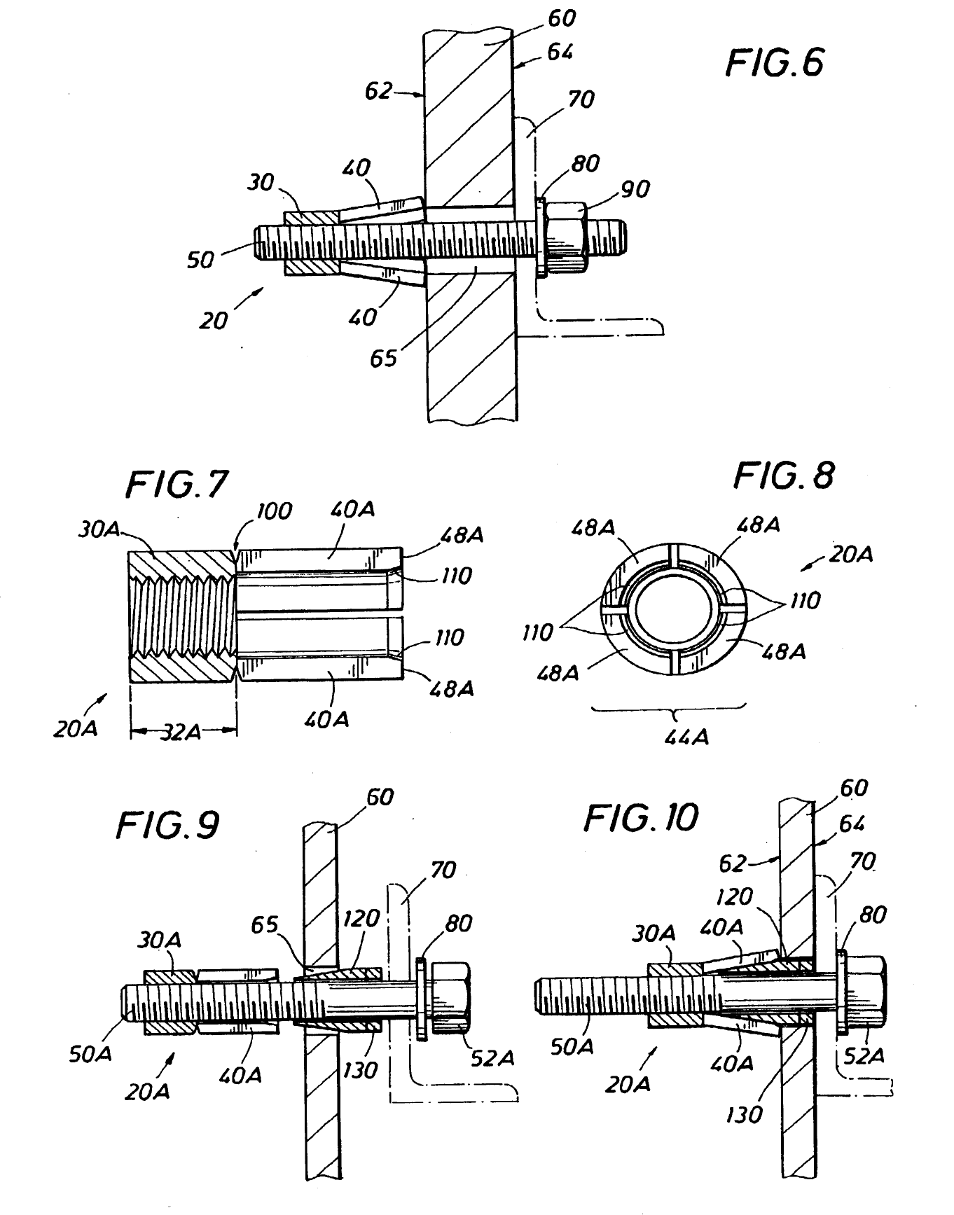

FIGS. 1 through 6, generally show a first embodiment of the invention. In FIG. 1, a holding portion 20 includes a housing 30 and a plurality of elongated members or wings 40. In this embodiment, each of the four equidistance elongated members 40 is bent radially outwardly into an extended position. A resilience in the material of the elongated members 40 tends to keep elongated members 40 in this extended position—for example, resisting a radial inwardly compression. Material for the elongated members 40 can include, but is not limited to, various forms of metal (e.g., aluminum), plastics, and the like. At the end of each plurality of elongated members 40 are end areas 48, which together make up an end surface area 44. The end surface area 44 is arranged and configured to serve as a bearing area, which will be described in detail with reference to FIG. 6 below.

Turning now to FIG. 2, the housing 30 of the holding portion 20 includes an outside diameter 34, an inside diameter 36, and a length of engagement 32. The length of engagement 32 in this embodiment is the length of the housing 30 that is adapted for engaging or coupling with a rod 50 (shown in FIG. 4). As can be seen in FIG. 2, the housing 30 is internally threaded with internally threaded roots 33 and internally threaded crests 35. As such, the engagement with the rod 50 in this embodiment will be a threaded coupling. While housing 30 is internally threaded in this embodiment, it is contemplated that housing 30 in other embodiments may be adapted to couple with the rod 50 in other manners—for example, via fixed attachments, clamped attachment, rivets and the like. As should become apparent to one of ordinary skill in the art, the length of engagement 32 can be a variety of different lengths depending on factors including, but not limited to, the material used in the housing 30, the material used in the rod 50, the coupling technique, and intended load to be supported by the holding portion 20. The length of engagement 32 is preferably greater than one-third of a length of a perimeter of the cross-sectional area of the rod 50. In this embodiment, the perimeter is the diameter of the rod 50 multiplied by the geometric constant, pi (roughly 3.14). Therefore, the length of engagement 32 in this embodiment is preferably equal to or greater than the diameter of the rod 50 (greater than one-third of a length of a perimeter of the cross-sectional area of the rod 50). As will become apparent to one of ordinary skill in the art, the length of the perimeter of the cross-sectional area can change with different shapes for the cross-sectional area of the rod 50—for example, ovals, triangles, squares, rectangles, and the like. It is to be expressly understood that the length of engagement 32 in other embodiments can be less than one-third of a length of a perimeter of the cross-sectional area of the rod 50. In such embodiments, the coupling technique and material used in the holding portion 20 and/or rod 50 can define the length. Further discussion of the length of engagement 32 follows below with reference to FIG. 6.

In the embodiment of FIGS. 1-6, the outside diameter 34 defines a cross-sectional area for housing 30, while the inside diameter 36 defines a cross-sectional area corresponding to the rod 50. As both the rod 50 (shown in FIG. 4) and housing 30 are threaded in this embodiment, the inside diameter 36 corresponds to the “major diameter” of the internally threaded portion of the housing 30 (e.g., root to root in the internally threaded housing 30 or crest to crest in the externally threaded rod 50).

Moving to FIG. 3, as referenced above, the inside diameter 36 of the holding portion 20 in this embodiment corresponds to the internally threaded root to root of the internally threaded portion of the housing 30. A minor diameter 38 is seen extending from crest to crest of the internally threaded crest 35 of the housing 30.

With general reference to FIGS. 2 and 3, the circular area defined by the outside diameter 34 in this embodiment is substantially equivalent to the inside diameter 36 plus the end areas 48 of the elongated members 40. In other words, the end surface area 44 (total end areas 48) in this embodiment are substantially an annulus area between the circular area defined by the outside diameter 34 and the inside diameter 36—each of the end areas 48 shaped as an annular arc. While the annular arcs of the shaped end areas 48 in this embodiment are shown with small gaps between them, it is completed that in other embodiments even smaller gaps will exist.

With reference to FIGS. 2-4, an illustration of the differences in cross-sectional areas is shown. When the aperture 65 in the structural member 60 is sized a cross-sectional area the same size as the housing 30 Oust allowing the housing 30 to pass through the aperture 65), the end surface area 44 of the end areas 48 of the elongated members 40 will be substantially the same area as the difference between the cross-sectional area of the aperture 65 and the cross-sectional area of the rod 50 (shown in FIG. 4). With this configuration, a maximum end surface area 44 can be extended through the aperture 65 (FIG. 4), allowing a reduced bearing force per surface area—for example, a larger area to distribute a load.

While the end surface area 44 described in the above embodiment is the difference between the area defined by the outside diameter 34 and the area defined by the inside diameter 36, it is contemplated that in more complex embodiments the end surface area 44 of end areas 48 of the plurality of elongated members 40 can exceed the area defined by the outside diameter 34 of the housing 30. For example, the holding portion 20 could be a frustum of a cone with a cylindrical bore extending the longitudinal distance of the holding portion 20—for example, corresponding to the diameter of the rod 50. In such an embodiment, the outside diameter 34 could start at the apex of the frustum of the cone and enlarge towards the base. The end surface area 44 of the end areas 48 of the elongated members 40 can be the difference between the area defined by the diameter of the base of the frustum of the cone and the internal diameter of the cylindrical bore extending to the base. With this “frustum of a cone” embodiment, the end surface area 44, similar to that described with reference to the above embodiment, can be the difference between the cross-sectional area of the aperture 65 and the cross-sectional area of the rod 50.

With reference to FIG. 4, the holding portion 20 is shown in an insertion position, being pushed through the aperture 65 in the structural member 60. The rod 50 is shown threaded to the housing 30 along a length of engagement 32 of the housing 30 of the holding portion 20. The rod 50, while shown in this embodiment as a threaded stud, in other embodiments can include a bolt, a smooth stud, a rivet and the like. And, with each of the different types of rods 50 used, the holding portion 20 can be adapted for an appropriate coupling.

The insertion of the holding portion 20 through the aperture 65 of the structural member 60 will radially urge or compress the plurality of elongated members 40 inwardly—against the above-referenced resilience to stay in an outwardly extended position—such that the elongated members 40 almost lay flush with the rod 50. Once again, as discussed above, in this embodiment the cross-sectional area of the inside diameter 36 of the housing 30 and the end surface area 44 of the plurality of elongated members 40 together are substantially the same as the cross-sectional area, defined by the outside diameter 34 of the housing 30. With this configuration, the bearing area of the end surface area 44 of the end areas 48 of the plurality of elongated members 40 can be substantially the difference between a cross-sectional area of the aperture 65 and the rod 50, where the cross-sectional area defined by the outside diameter 34 is the same as the cross-sectional area of the aperture 65—just allowing the holding portion 20 to pass therethrough.

It should be expressly understood that while the holding portion 20 has been shown with a circular cross-sectional area in this embodiment, in other embodiments the cross-sectional area can take on different shapes—e.g., squares, rectangles, triangles, etc., which can ultimately depend on the rod 50 being used and the aperture 65 through which the holding portion 20 will be inserted.

FIG. 5 shows the holding portion 20 moving back to a memory position after insertion through the aperture 65. The memory position in this embodiment is the extended position caused by the resilience in the material of the holding portion 20 tending to urge the plurality of elongated members 40 into the extended position.

FIG. 6 shows the holding portion 20 in a bearing position with the surface area 62 of the structural member 60. In bringing the holding portion 20 into contact with the blind surface area 62 from the position shown in FIG. 5, in this embodiment, the elongated members 40 and housing 30 can maintain a positional relationship with the rod 50—that is, the rod 50 need not be further threaded through the housing 30 of the holding portion 20. Rather, the holding portion 20 coupled to the rod 50 can be brought into the bearing position by pulling the rod 50 until the end surface area 44 of the end areas 48 of the elongated members 40 contacts the blind surface area 62 of the structural member 60. An element 70 can be mounted to the rod 50; and, then by maintaining tension of the rod 50, a washer 80 and nut 90 can be threaded on the rod 50 to bring the element 70 into contact with an exposed surface area 64 of the structural member 60. The friction force of the end surface area 44 of the end areas 48 with the blind surface area 62 prevents rotation of the holding portion 20. With this maintenance of positional relationship, no further access is needed on the blind side of the structural member 60. For example, the rod 50 in this embodiment need not be further threaded through the housing 30 to bring the holding portion 20 into a bearing position with the blind surface area 62. Additionally, the rod 50 in this embodiment need not be further threaded through the housing 30 to bring the element 70 into contact with the exposed surface area 64 of the structural member 60. As such, the holding portion 20 in this embodiment is particularly helpful when limited access or space is available on the blind side of the structural member 60. While this positional relationship has been described with reference to this embodiment, it is to be expressly understood that further threading through the housing 30 of the holding portion 20 can occur, if desired, as will be described with reference to another embodiment below.

The holding portion 20 through many of the features described herein is configured to resist removal of the rod 50. In this resistance of the removal of the rod 50, forces are transmitted from the rod 50 through the length of engagement 32 to the elongated members 40, forcing the elongated members 40 into a bearing position with a blind surface area 62 of the structural member 60. Thus, in the structural design of the holding portion 20, consideration is given to the following: (1) the length of engagement 32 in coupling the rod 50 to the housing 30 to withstand a loss of such coupling, (2) the elongated members 40 to withstand buckling, and (3) the bearing surface area between the end surface area 44 of the end areas 48 and the blind surface area 62 to withstand crushing (e.g., a point load failure from too much force per unit area) of the structural member 60. In the embodiment described herein, the length of engagement 32 is threaded at a length for a predetermined design load. As such, a specified number of threads and/or specified length of engagement 32 should be used to ensure that the housing 30 does not disengage with the rod 50 when a pull force is applied to the rod 50. For example, with reference to the embodiment of FIGS. 1-6, stripping (a disengagement) can occur either in the internal threads of the housing 30 or in the external threads of the rod 50. As such, the length of engagement 32 in this embodiment has a length large enough to resist this stripping. Preferably, as referenced above, the length of engagement 32 in the embodiment of FIGS. 1-6 is greater than the diameter of the rod 50. As will become apparent to one of ordinary skill in the art, the length of engagement 32 can increase to account for a difference of materials between the housing 30 and the rod 50. For example, one of the threaded portions (either the housing 30 or the rod 50) could have a material such as plastic while the other threaded portion (either the housing 30 or the rod 50) could have a material such as steel—the plastic generally deforming at a lower load than the steel. The increase in the length of engagement 32 distributes a design load along the length of engagement 32 resisting the stripping of either the internal threads for the housing 30 or the external threads for the rod 50—regardless of whether the weaker material (the one which deforms first) is in the housing 30 or the rod 50.

To resist buckling in the elongated members 40, several buckling factors should be considered, including the length of the elongated members 40. Generally, for a given material, as the length in the elongated members 40 increase, so should the cross-sectional area of that elongated member 40 to adequately prevent buckling. Additionally, in the embodiment of FIGS. 1-6, a curvature in the elongated members 40 helps resist buckling. As can be seen in the embodiment of FIGS. 1-6, each of the elongated members 40 has a curvature that is arced. The structural benefits of such an arced configuration in resistance to buckling should become apparent to one of ordinary skill in the art. For example, by illustration, a piece of paper on a desk sat on its end can resist more compressive strength by being curved into an arc rather than by simply being set planarly straight up. While an arced curvature is shown in the embodiment of FIGS. 1-6 as a preferred curvature, it is contemplated that other forms of curvature can be used—for example, different angles of bending including bending at right angles and corrugated designs.

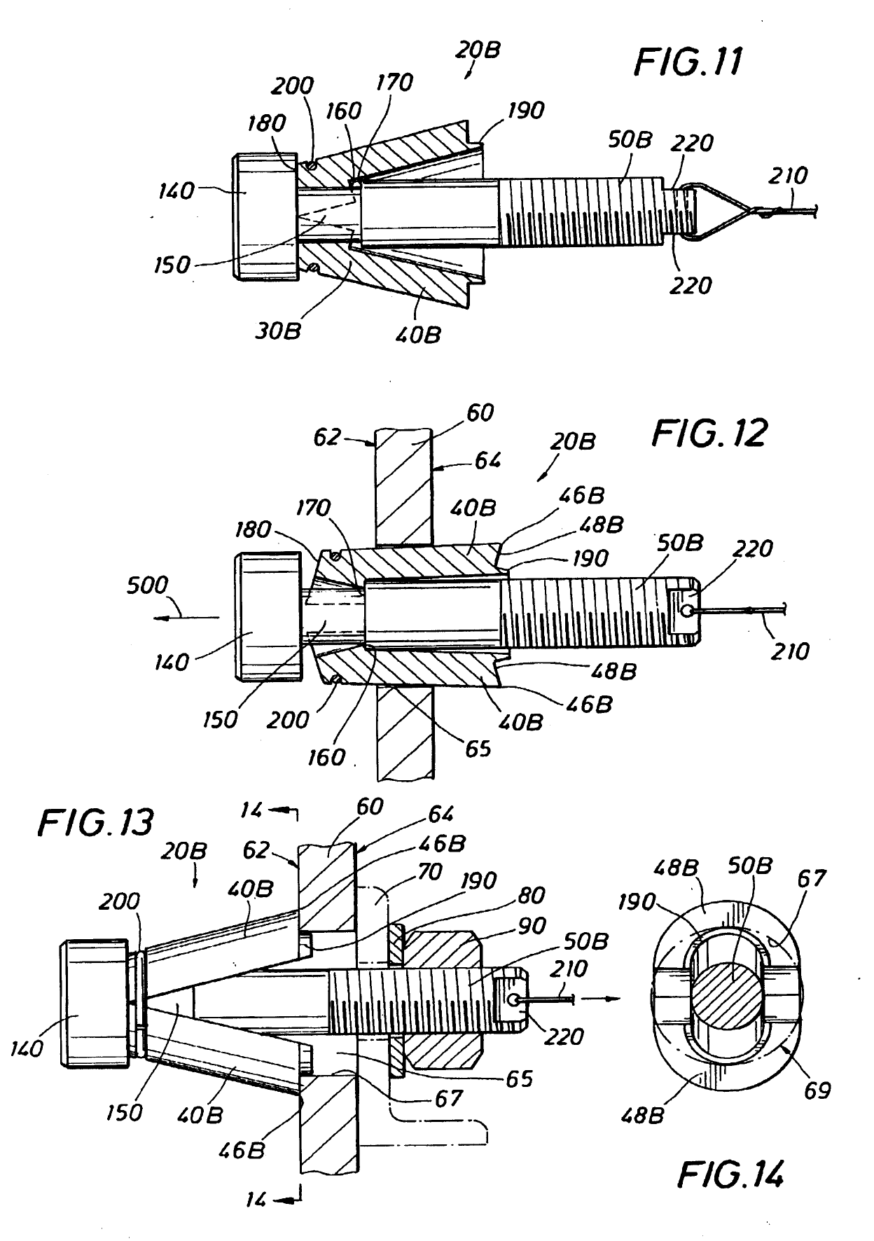

To resist a crushing of the structural member 60, the end surface area 44 of the end areas 48 of the elongated members 40 is maximized (while not sacrificing simplicity of design) to distribute the load over the blind surface area 62 of the structural member 60. Preferably, this end surface area 44 will be the difference between a cross-sectional area of the aperture 65 and the cross-area of the rod 50 to be inserted in the aperture 65. In the bearing contact of the end surface area 44 of the end areas 48 of the elongated members 40, this embodiment will always have at least three of the end areas 48 of the elongated members 40 in contact with the blind surface area 62. Additionally, it is contemplated that end areas 48 can be angled, similar to the end areas 48B, described in detail below with reference to FIGS. 11-14 below.

As an illustrative use of the embodiment described with reference to FIGS. 1-6, a rod 50 is inserted through an aperture 65 in a structural member 60 to fasten an element 70 to the structural member 60. The rod 50 can be one of any of the commercially available rods 50 described including, but not limited to bolts, threaded studs, smooth studs, rivets and the like. The structural member 60 can be any number of structures—for example, a wall, a ceiling, a floor, a door, a circuit board, plastic pieces, boards, substrates, etc. Likewise, the element 70 can be any number of items, including another structural member 60. Generally, the structural member 60 and element 70 are two distinct “things”, which are desired to be coupled to one another—preferably as shown in several embodiments of the invention, the element 70 being coupled or fastened to the structural member 60. The desired configuration and size of the rod 50 and holding portion 20 can defined by the intended use. In this embodiment, the rod 50 is initially coupled to the housing 30 (the coupling contact being at the length of engagement 32) of the holding portion 20. The coupling of the rod 50 to the housing 30 can take on one of many coupling techniques, generally described herein, which should be apparent to one of ordinary skill in the art. The coupling technique in the embodiment of FIGS. 1-6 is a threaded coupling. At rest, the elongated members 40 are urged outwardly in an extended position by the resilience in the material. After coupling the rod 50 to the holding portion 20, the rod 50 and holding portion 20 are inserted into the aperture 65, whereupon the aperture 65 radially compresses the outwardly urged elongated members 40 inwardly into an insertion position. After insertion through the aperture 65, the elongated members 40 return to their memory position—their outwardly urged extended position. An element 70 can then be received on the end of the rod 50 adjacent to an exposed surface area 64 of the structural member 60, whereupon the rod 50 is pulled partially back through the aperture 65 allowing the end surface area 44 of the end areas 48 to come into a bearing position with the blind surface area 62 of the structural member 60. The friction force between the end surface area 44 of the end areas 48 and the blind surface area 62 of the structural member 60 resists rotation of the holding portion 20. Therefore, the rod 50 maintains a positional relationship with the holding portion 20. A washer 80 and nut 90 are then threaded on the rod 50 engaging the element 70 with the exposed surface area 64 of the structural member 60. The holding portion 20 reisists removal of the rod 50 through a length of engagement 32 in the housing 30 of the holding portion to the elongated members 40, which distribute their load over the end surface area 44 of the end areas 48 on the blind surface area 62—reducing the bearing force per area on the blind surface area 62 of the structural member 60.

In the embodiment of FIGS. 7-10, the holding portion 20A includes an annular notch 100, which helps define movement of the four equidistant elongated members 40A between an insertion position and an extended position. As can be seen in FIG. 7, the at rest position of the elongated members 40 is an insertion position.

With reference to FIGS. 7 and 8, at the end of each of the elongated members 40A is a tapered interior end 110 which, as will be described below, facilitates the urging of the elongated members 40 to an extended position.

Turning now to FIG. 9, the holding portion 20A, coupled to a rod 50A, is in an insertion position after being pushed through the aperture 65 of the structural member 60. In this embodiment, the rod 50A is shown as a bolt with a bolt head 52A. Thus, to urge the elongated members 40A to an extended position (as seen in FIG. 10), a tapered sleeve 120 and, if needed, a spacer 130 can be inserted after the insertion of the holding portion 20A. The tapered sleeve 120 can take on a variety of shapes, depending on the configuration and design of the elongated members 40A. For example, in the illustrated embodiment, the tapered sleeve 120 has a circular cross-sectional area. To facilitate the alignment of this tapered sleeve 120, each of the elongated members 40A, as referenced above, includes a tapered interior end 110, which is adapted to receive the tapered sleeve 120. In addition to urging the elongated members 40A into an extended position, the tapered sleeve 120 centers the rod 50A within the aperture 65. In some embodiments, the thickness of the structural member 60 may not be known. As such, the spacer 130 can be inserted after the tapered sleeve 120, facilitating the tapered sleeve 120 in urging the elongated members 40A to their extended position and centering the rod 50A in the aperture 65. The spacer, similar to the tapered sleeve 120, can take on a variety of shapes. Preferably, the spacer 130 has a circular cross-sectional area with at least one opening to allow the spacer 130 to be placed over and around the rod 50A.

FIG. 10 shows the holding portion 20A in an extended position and bearing position with the blind surface area 62 of the structural member 60. This bearing contact of the end surface area 44A of the end areas 48A with an blind surface area 62 of the structural member 60 is similar to that described with reference to FIG. 6. It is contemplated that spacer(s) 130 of a plurality of lengths would be provided for use with the fastener 20A.

As an illustrative use of the embodiment described with reference to FIGS. 7-10, a rod 50A is inserted through the aperture 65 in a structural member 60 to fasten an element 70 to the structural member 60. Similar to the illustrative use, described with reference to FIGS. 1-6 above, the element 70 and structural member 60 can be any number of “things”. In this embodiment, the rod 50A (such as a bolt) can be inserted through the washer 80, the element 70, the tapered sleeve 120, and, if needed, spacer(s) 130. Then, the rod 50A can be threaded along the length of engagement 32A of the housing 30A of the holding portion 20A, whereupon the holding portion 20A and a portion of the rod 50A are inserted through the aperture 65 in the structural member 60. The tapered sleeve 120, and, if needed, spacer(s) 130, can then be moved down the rod 50A and further into the aperture 65, centering the rod 50A and urging the elongated members 40A to an extended position. As discussed, if needed, one or more spacers 130 can be inserted after the tapered sleeve 120 by inserting the spacer 130 over and around the rod 50A in contact with the tapered sleeve 120. The rod 50A can then be partially be pulled back through the aperture 65 bringing the end surface area 44A of the elongated members 40A into the bearing position with the blind surface area 62 of the structural member 60. Friction forces of the end surface area 44A of the end areas 48A with the blind surface area 62 and friction forces with the tapered sleeve 120 helps resist rotation of the holding portion 20A. To bring the element 70 into contact with an exposed surface area 64 of the structural member 60, the rod 50A can be further rotated through the housing 30A of the holding portion 20A. To increase resistance between the holding portion 20A and the rod 50A, tension can be maintained on the rod 50A while threading to increase the friction force between end surface area 44A of the end areas 48A and the blind surface area 62 of the structural member 60. Additionally, the tapered sleeve 120 can be designed of a high friction material, such that friction is created both between the tapered sleeve 120 and the aperture 65 and the tapered sleeve 120 and the elongated members 40A. As is now apparent to one of ordinary skill in the art, the threaded rod 50 of FIGS. 1-6 can be interchanged with the bolt described with reference to FIGS. 7-10.

With reference to FIGS. 11-14, another embodiment of the invention is shown. In this embodiment, as generally shown in FIGS. 10 and 11, a rod 50B has a holding portion 20B slidingly coupled thereto. The rod 50B in this embodiment has a shoulder 170, a reduced diameter neck 150, and a head 140. The holding portion 20B in this embodiment includes two elongated members 40B, a compressive band 200, and a housing 30B, which moves slidingly with respect to the neck 150 of the rod 50B. The two elongated members 40B are semicircular halves, which will be described in more detail with reference to FIG. 14 below. The housing 30B includes a first shoulder 160 and a second shoulder 180. The compressive band 200 is positioned and designed to create a radially compressive force on an end of the holding portion 20B, adjacent to the second shoulder 180. When the holding portion 20B is in the extended position, as shown in FIG. 11, the two elongated members 40 are moved to the extended position and the housing 30B slides towards the head 140 with the second shoulder 180 preferably mating flush therewith. Upon insertion of holding portion 20B and rod 50B into an aperture 65, the two elongated members 40B are compressed radially inwardly into an insertion position, expanding the compressive band 200. The housing 30B slides towards the shoulder 170 of the rod 50B, with the first shoulder 160 preferably mating flush therewith.

With reference to FIGS. 11-14, the end of each the elongated members 40B include lips 190, which has been configured to center the holding portion 20B (and hence, the rod 50B) in a central location within the aperture 65. The lips 190 in this embodiment come in contact with an annular surface area 67 (best seen in FIG. . 13) of the aperture 65. In FIG. 14, the lips 190 are shown contacting the annular surface area 67 (shown in phantom) at an upper and lower part of the annular surface area 67. To help ensure that the lips 190 comes in contact with the annular surface area 67, a tension wire 210 can be utilized. The tension wire 210 in this embodiment is put through a loop (best seen in FIGS. 12 and 14) inside a wrench flat 220 at the end of the rod 50. The loop in the wrench flat 220 is preferably smaller than the diameter of the rod 50B; and, when the rod 50 is threaded as shown, preferably smaller than a minor diameter 38 (for example, seen in FIG. 3). As seen in FIG. 12, as the rod 50B and holding portion 20B are inserted through the aperture 65 in the direction, indicated by arrow 500, the tension wire 210 is pulled to ensure that the elongated members 40B are not inadvertantly pushed through the aperture 65. As soon as tips 46B of the elongated members 40B clear the annular surface area 67 of the aperture 65, the compressive band 200 automatically urges the lips 190 into contact with the annular surface area 67 of the aperture 65.

With reference to FIGS. 12 and 14, the end areas 48B of the two elongated members 40B can be seen. In FIG. 14, the end areas 48B extend just beyond the circumference 69 (shown in phantom) of the cross-sectional area of the aperture 65. The end areas 48B in this embodiment have an angled configuration which allows full bearing contact with the blind surface area 62.

Turning once again to FIG. 13, the tension wire 210 can provide the force necessary to establish friction force between the end areas 48B and blind surface area 62 of the structural member 60—thus, allowing the nut 90 to be threaded on the rod 50B, while the holding portion 20B maintains its positional relationship with the bolt or rod 50B. As an additional aid, a wrench (not shown) can be clamped on to the wrench flats 220 helping to maintain the positional relationship of the holding portion 20B with the bolt or rod 50B by preventing rotation of the rod 50B.

As an illustrative example of the use of the embodiment described with reference to FIGS. 11-14, a rod 50B having a housing 30B, coupled thereto is inserted into the aperture 65, whereupon the elongated members 40B are compressed radially inward into an insertion position. Upon clearance of tips 46B of the elongated members 40B of the annular surface area 67 of the aperture 65, the compressive band 200 urges the lips 190 into contact with the annular surface area 67 of the aperture 65. Then, an element 70 can be received on the rod 50B, whereupon a force is applied on the tension wire 210 bringing the end areas 48B into a bearing position for fill bearing contact. While maintaining tension on the tension wire 210 (to increase the friction force between the end areas 48B and the blind surface area 62), a washer 80 and nut 90 are inserted on the rod 50B to threadingly mate the element 70 into contact with an exposed surface area 64 of the structural member 60. Additionally, a wrench (not shown) can be clamped on to the wrench flats 220 helping to maintain the positional relationship of the holding portion 20B with the bolt or rod 50B. The holding portion 20B resists removal of the rod 50B through the head 140, first shoulder 180, and elongated members 40, which have a full distributed load over the end areas 48B on blind surface area 62—reducing the bearing force per area of the blind surface area 62 of the structural member 60.

The foregoing disclosure and description is intended only to be illustrative and explanatory thereof. To the extent foreseeable, various changes in the size, shape, and materials, as well as in the details of illustrative construction and assembly, may be made without departing from the spirit of the invention.

1. A holding portion of a fastener for fastening an element to a structural member, wherein the fastener includes a rod and the structural member has an aperture, said holding portion comprising:
a housing having a length of engagement with the rod;
a plurality of elongated members disposed with said housing, wherein
said length of engagement is greater than one-third of a length of a perimeter of a cross-sectional area of the rod,
said plurality of elongated members are moveable between an insertion position and an extended position,
said plurality of elongated members are in said insertion position upon insertion of said holding portion in the aperture, and
upon clearance of said holding portion from the aperture, said plurality of elongated members are moved to said extended position to resist removal of said holding member through the aperture.

2. The holding portion of claim 1, wherein
the cross-sectional area of the rod is circular, and
said length of engagement is greater than a diameter of the rod.

3. (Cancelled)

4. The holding portion of claim 1, wherein
said plurality of elongated members are moved to said extended position via a resilience in said plurality of elongated members.

5. The holding portion of claim 1, wherein
said plurality of elongated members can further be moved to a bearing position while maintaining a positional relationship with the rod.

6-17 (Cancelled)

18. A method of fastening an element to a structural member, comprising the steps of:
positioning a rod with a housing of a holding portion having a plurality of elongated members;
inserting said holding portion and the rod into an aperture of the structural member;
moving said plurality of elongated members to an extended position after insertion through the aperture;
contacting said plurality of elongated members of said holding portion with the structural member while said plurality of elongated members maintain positional relationship with the rod; and
resisting removal of said holding portion through the aperture with the step of moving,.

19-20 (Cancelled)

21. The method of claim 18, wherein said step of moving said holding portion to an extended position includes utilizing a resilience in said plurality of elongated members after said step of inserting said holding portion into the aperture of the structural member.

22. The method of claim 18, wherein in said maintenance of positional relationship with the rod during said step of contacting said elongated members of said holding portion with the structural member, the rod does not move further through said housing.

23. A holding portion of a fastener for fastening an element to a structural member, wherein the fastener includes a rod and the structural member has an aperture, said holding portion comprising:
a housing adapted to threadly receive the rod; and
a plurality of elongated members disposed with said housing, wherein
an end surface area of said plurality of elongated members is substantially the difference between a cross-sectional area of the aperture and a cross-sectional area of the rod,
said plurality of elongated members are moveable between an insertion position and an extended position,
said plurality of elongated members are in said insertion position upon insertion of said holding portion in the aperture, and
upon clearance of said holding portion from the aperture, said plurality of elongated members move to said extended position to resist removal of said holding member through the aperture.

24. The holding portion of claim 23, wherein the aperture has a substantially circular cross sectional area.

25. The holding portion of claim 24, wherein
the rod has a substantially circular cross sectional area,
said difference between the cross-sectional area of the aperture and the cross-sectional area of the rod is an annulus, and
the end surface area of each of said plurality of elongated members is an annular arc shaped surface area.

26. The holding portion of claim 25, wherein
said annular arc shaped surface areas provide a reduced bearing force per surface area.

27. The holding portion of claim 25, wherein
said plurality of elongated members can further be moved to a bearing position while maintaining a positional relationship wit the rod.

28. (Cancelled)

29. The holding portion of claim 25, wherein
said plurality of elongated members are moved to said extended position via a resilience in said plurality of elongated members.

30. The holding portion of claim 25, wherein
said plurality of elongated members can further be moved to a bearing position while maintaining a positional relationship with the rod.

31. A method of fastening an element to a structural member, comprising the steps of:
engaging a rod with a housing of a holding portion at a predetermined length of engagement, wherein
said holding portion includes a plurality of elongated members, and
said length of engagement is greater than one-third of a length of a perimeter of a cross-sectional area of the rod;
inserting said holding portion into an aperture of the structural member;
moving said holding portion to an extended position to form a support after insertion through the aperture;
contacting said plurality of elongated members with the structural member;
resisting removal of said holding portion through the aperture; and
positioning the element with the rod.

32-35 (Cancelled)

36. The method of claim 31, further comprising the step of:
maintaining positional relationship between said elongated members and the structural member during said step of contacting.

37. The method of claim 31, further comprising the step of:
maintaining the positional relationship between said elongated members and the rod during said step of contacting.

38. (Cancelled).

39. A method of fastening an element to a structural member, comprising the steps of:
engaging a rod with a housing of a holding portion having a plurality of elongated members;
inserting said holding portion and the rod into an aperture of the structural member, wherein an end surface area of said plurality of elongated members is substantially the difference between a cross-sectional area of the aperture and a cross-sectional area of the rod;
moving said holding portion to an extended position after insertion through the aperture;
contacting said elongated members of said holding portion with the structural member; and
resisting removal of said holding portion through the aperture with the step of contacting.

40-41 (Cancelled)

42. The method of claim 39, wherein said step of moving said holding portion to an extended position includes utilizing a resilience in said plurality of elongated members after said step of inserting said holding portion into the aperture of the structural member.

43. A holding portion of a fastener for fastening an element to a structural member, wherein the fastener includes a rod and the structural member has an aperture, said holding portion comprising:
a housing adapted to receive the rod; and
a plurality of elongated members disposed with said housing, wherein
said plurality of elongated members are moveable between an insertion position and an extended position,
at least one of said plurality of elongated members has a curvature,
said plurality of elongated members are in said insertion position upon insertion of said holding portion in the aperture, and
upon clearance of said holding portion from the aperture, said plurality of elongated members are moved to said extended position.

44-45 (Cancelled)

46. The holding portion of claim 43, wherein
said plurality of elongated members are moved to said extended position via a resilience in said plurality of elongated members.

47. The holding portion of claim 43, wherein
said housing receives the rod along a length of engagement, and
said length of engagement is greater than one-third of a length of a perimeter of a cross-sectional area of the rod.

48. The holding portion of claim 43, wherein
an end surface area of said plurality of elongated members is substantially the difference between a cross-sectional area of the aperture and a cross-sectional area of the rod.

49. The holding portion of claim 43, wherein
said plurality of elongated members can further be moved to a bearing position while maintaining a positional relationship with the rod.
